(19) United States
(12) Patent Application Publication
(10) Pub. No.: US 2008/0164785 A1
(43) Pub. Date: Jul. 10, 2008

(54) Positioning Structure for a Direct Drive Torque Motor

(76) Inventor: Chih-Yu WANG, Taichung (TW)

Correspondence Address: Dr. BANGER SHIA, 102 Lindencrest Ct., Sugar Land, TX, 77479-5201, US

(21) Appl. No.: 11/621,171

(22) Filed: Jan. 9, 2007

(51) Int. Cl. H02K 11/00; H02K 5/16; F16C 41/04

(52) U.S. Cl. 310/68 B; 310/90; 384/448

(57) ABSTRACT

A positioning structure for a direct drive torque motor, on the fixed portion of the positioning bearing are formed a first positioning surface and a second positioning surface, and on the rotating portion of the positioning bearing is formed a reference surface. The first positioning surface is positioned against the base, the second positioning surface is positioned against the stator, and the reference surface is positioned against the optical scale. By arrangements, the base, the rotor, the stator, and the optical scale of the motor can be assembled precisely without the use of extra assistant mechanisms. Therefore, it not only saves the cost but also improve the assembly convenience and precision.

### BACKGROUND OF THE INVENTION

1. Field of the Invention

The present invention relates to a positioning structure for a torque motor, and more particularly to a positioning bearing used as a positioning structure for positioning the base, the stator, the rotor and the optical scale.

2. Description of the Prior Art

In current industrial field, rotating platform is used in various equipments or mechanism, such as: wafer inspection equipment, automatic equipment, indexing plate, and the power source of the rotating platform is supplied from torque motor.

The abovementioned respective equipments that need to perform rotating operation are required to work very precisely in operation, therefore, the torque motor must work very smoothly and stably. To make the rotor cooperate accurately with the motor base and the stator, the conventional method is to arrange an optical scale between the motor and the stator as an error correction reference.

It is to be noted that the rotor, the stator, the bearing and the optical scale of the conventional torque motor are predisposed on the motor base and then cooperate with each other. To install the respective subassemblies of the motor successfully, the motor base must be machined to have many mounting structures, or it has to use many extra assistant mechanisms to install the motor subassemblies.

However, due to the manufacturing error accumulation, there will be obvious assembly errors in the motor after subassemblies are assembled together Therefore, the motor must be adjusted carefully before leaving factory, and even after a certain time of use after leaving factory, the motor must be checked often to make sure whether the subassemblies are stilled positioned in place.

In addition, according to the existing design, when adjusting the assembly precision between the rotor and the stator, the user must adjust the rotor, the bearing seat, and the bearing, so that the assembly errors can be eliminated. Therefore, the adjustment operation is inconvenient.

The author of the invention has developed a positioning structure for a torque motor, with which the base, the rotor, the stator, and the optical scale of the motor can be assembled precisely without the use of extra assistant mechanisms. Hence, the number of subassemblies is reduced a lot, and the whole rigidity, strength and stability of the motor are improved considerably.

### SUMMARY OF THE INVENTION

The primary objective of the present invention is to provide a positioning structure for a direct drive torque motor, on the fixed portion of the positioning bearing are formed a first positioning surface and a second positioning surface, and on the rotating portion of the positioning bearing is formed a reference surface. The first positioning surface is positioned against the base, the second positioning surface is positioned against the stator, and the reference surface is positioned against the optical scale. By arrangements, the base, the rotor, the stator, and the optical scale of the motor can be assembled precisely without the use of extra assistant mechanisms. Therefore, the present invention not only saves the cost but also improves the assembly convenience and precision.

### BRIEF DESCRIPTION OF THE DRAWINGS

FIG. 1 is a cross sectional view of a torque motor in accordance with the present invention; and

FIG. 2 is a cross sectional view of a part of the torque motor in accordance with the present invention.

### DETAILED DESCRIPTION OF THE PREFERRED EMBODIMENT

The present invention will be more clear from the following description when viewed together with the accompanying drawings, which show, for purpose of illustrations only, the preferred embodiment in accordance with the present invention.

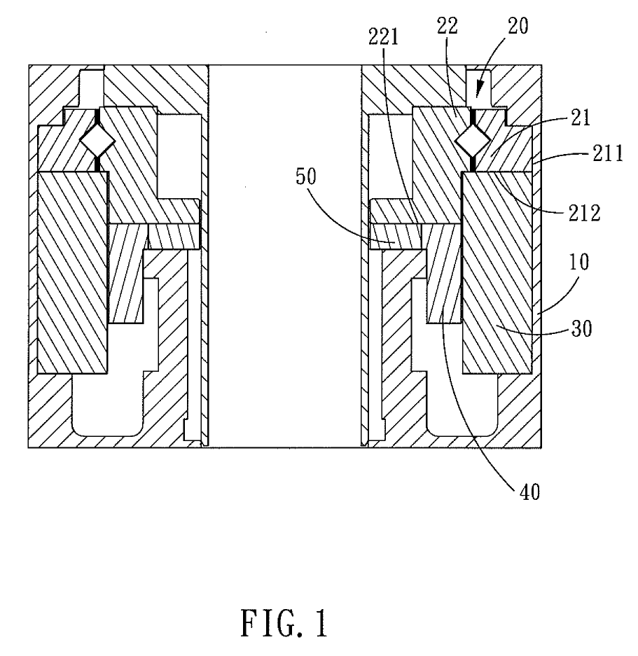

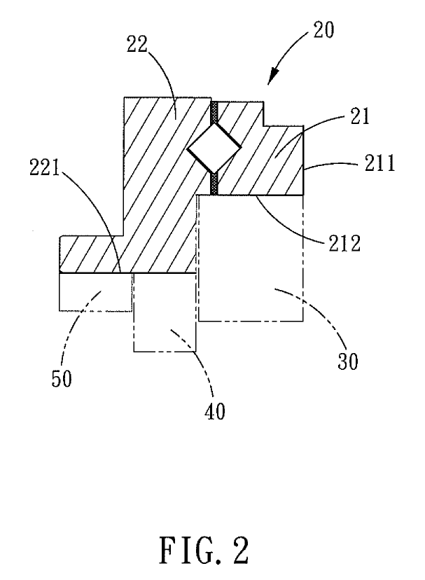

Referring to FIGS. 1 and 2, a positioning structure for a direct drive torque motor in accordance with the present invention comprises: a base 10, a positioning bearing 20, a stator 30, a rotor 40, and an optical scale 50.

The base 10 is a mounting frame on which the respective subassemblies of the motor are installed.

The positioning bearing 20 includes a fixed portion 21 and a rotating portion 22. On the outer surface of the fixed portion 21 are formed a first positioning surface 211 and a second positioning surface 212, and on the outer surface of the rotating portion 22 is formed a reference surface 221. The first positioning surface 211 of the bearing 20 is positioned against the base 10.

The stator 30 is a stationary magnetic subassembly of the motor and is fixed in the base 10. One end surface of the stator 30 is positioned against the second positioning surface 212 of the positioning bearing 20.

The rotor 40 is a rotary magnetic subassembly of the motor and is rotatably disposed in the base 10 in such a manner that one end surface of the rotor 40 is directly positioned against the reference surface 221 of the positioning bearing 20.

The optical scale 50 is an optical instrument for measuring the displacement error of the subassemblies. One end of the optical scale 50 is directly positioned against the reference surface 221 of the positioning bearing 20.

The positioning bearing 20 of the present invention serves as a mounting and positioning base for positioning the subassemblies of the motor, including the base 10, the rotor 40, the stator 30 and the optical scale 50. Since it doesn't need any extra assistant mechanisms, the present invention not only saves the cost but also improves the assembly convenience and precision.

Referring to FIGS. 1 and 2 again, the fixed portion 21 of the positioning bearing 20 is formed with the first and second positioning surfaces, and on the rotating portion 22 is formed a reference surface 221. The first positioning surface 211 is to be against the base 10, the second positioning surface 212 is positioned against the stator 30, and then the reference surface 221 is positioned against the rotor 40 and the optical scale 50. Therefore, as long as the size of the positioning bearing 20 is up to the standard of precision during production, the rest subassemblies of the motor, such as the base 10, the rotor 40, the stator 30 and the optical scale 50 can be assembled accurately.

It is to be noted that the present invention directly uses the positioning bearing 20 as a central reference structure to position the respective subassemblies of the motor (including the rotor 40, the stator 30, the optical scale 50, and the base 10). Namely, the respective subassemblies of the motor are positioned and assembled using the positioning bearing 20 as a reference object, unlike the conventional structure that must use extra assistant mechanisms to install the subassemblies of the motor. Since the number of the subassemblies is reduced, after the subassemblies are assembled, the manufacturing and assembling error accumulation can be reduced.

Moreover, the positioning bearing 20 of the present invention is not a new extra subassembly of the motor, because there originally was an ordinary bearing between the rotor 40 and the stator 30 as a rotation transmission mechanism. In the present invention, the conventional bearing is replaced with a special bearing 20 with the first and second positioning surface and the reference surface 221, therefore, the cost will not be increased a lot.

Finally, since the respective subassemblies of the motor, such as the base 10, the stator 30, the rotor 40 and the optical scale 50, are positioned against the positioning bearing 20 directly, the connection between the respective subassemblies becomes simple and the number of subassemblies is reduced a lot. Hence, the whole rigidity, strength and stability of the motor are improved considerably.

While we have shown and described various embodiments in accordance with the present invention, it is clear to those skilled in the art that further embodiments may be made without departing from the scope of the present invention.

What is claimed is:

1. A positioning structure for a direct drive torque motor comprising:
a base serving as a mounting frame for mounting respective subassemblies of the motor;
a positioning bearing including a fixed portion and a rotating portion, on an outer surface of the fixed portion being formed a first positioning surface and a second positioning surface, and on an outer surface of the rotating portion being formed a reference surface, the first positioning surface of the positioning bearing being positioned against the base;
a stator being fixed in the base in such a manner that one end surface of the stator is positioned against the second positioning surface of the positioning bearing directly;
a rotor being rotatably disposed in the base in such a manner that one end surface of the rotor is positioned against the reference surface of the positioning bearing; and
an optical scale being an optical instrument for measuring displacement error of the subassemblies, one end of the optical scale is directly positioned against the reference surface of the positioning bearing.
